(19) United States
(12) Patent Application Publication
(10) Pub. No.: US 2007/0212526 A1
(43) Pub. Date: Sep. 13, 2007

(54) SUBSTRATE STRUCTURE AND METHOD FOR MANUFACTURING PATTERNED LAYER THEREON

(75) Inventors: CHING-YU CHOU, Taipei Hsien (TW); DAI-YUAN LEE, Taipei Hsien (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignee: ICF TECHNOLOGY CO., LTD., Hsinchu (TW)

(21) Appl. No.: 11/557,856

(22) Filed: Nov. 8, 2006

(30) Foreign Application Priority Data
Mar. 3, 2006 (TW) 95107207

(51) Int. Cl. B41M 5/00

(52) U.S. Cl. 428/195.1

(57) ABSTRACT

A substrate structure includes a substrate and a plurality of banks formed on the substrate. A substrate structure includes a substrate and a plurality of banks formed on the substrate. The banks and the substrate cooperatively define a plurality of accommodating rooms. The accommodating rooms are configured for accommodating ink. A width W of the bank is a function of a height H of the bank. A plot of the function W=f (H) has at least one discontinuity point. A left hand limit at the at least one discontinuity point being greater than a right hand limit at the at least one discontinuity point.

### TECHNICAL FIELD

The present invention relates to a substrate structure and a method for manufacturing a patterned layer on the substrate substructure.

### BACKGROUND

Methods for forming a patterned layer mainly include a photolithography method and an inkjet method.

The photolithography method includes the steps of: providing a substrate; applying a photoresist film onto the substrate; exposing the photoresist film using a photomask with a predetermined pattern; and developing the photoresist film to form a patterned layer. However, a large part of the photoresist material is wasted and the efficiency thereof is low as a result, thus increasing the cost.

Referring to FIG. 23, the ink jet method includes the steps of: providing a substrate structure 700 with a plurality of banks 704, the substrate 702 and the banks 704 cooperatively defining a plurality of accommodating rooms; jetting ink 706 into the accommodating rooms; solidifying the ink 706 to form a patterned layer. In the ink jet method, the efficiency of the material is increased. Thus the ink jet method decreases the cost.

In the ink jet method, the ink 706 is still in a liquid state when the ink 706 is deposited into the accommodating rooms. When the substrate structure 700 is shaken, the ink 706 in one accommodating room may overflow the banks 704, diffuse into an adjacent accommodating room and mix with the ink 706 in the adjacent accommodating room. Thus, when the ink 706 is solidified, the quality of the patterned layer decreases due to the intermixing of ink 706 between different accommodating rooms.

It is therefore desirable to find a new substrate structure and a new method which can overcome the above mentioned problems.

### SUMMARY

In a preferred embodiment, a substrate structure includes a substrate and a plurality of banks formed on the substrate. The banks and the substrate cooperatively define a plurality of accommodating rooms. The accommodating rooms are configured for accommodating ink. A width W of the bank is a function of a height H of the bank. A plot of the function W=f (H) has at least one discontinuity point. A left hand limit at the at least one discontinuity point being greater than a right hand limit at the at least one discontinuity point.

Other advantages and novel features will become more apparent from the following detailed description of the present substrate structure and the present method, when taken in conjunction with the accompanying drawings.

### BRIEF DESCRIPTION OF THE DRAWINGS

Many aspects of the present substrate structure and the present method can be better understood with reference to the following drawings. The components in the drawings are not necessarily drawn to scale, the emphasis instead being placed upon clearly illustrating the principles of the present substrate structure and the present method.

FIG. 1 is a schematic, cross-sectional view of a substrate structure in accordance with a first embodiment;

FIG. 2 is a schematic, plan view of the substrate structure of FIG. 1;

FIG. 3 is a chart of a function W=f (H) in accordance with the first embodiment;

FIG. 4 is a schematic, plan view of a substrate structure in accordance with a second embodiment;

FIG. 5 is a schematic, cross-sectional view of a substrate structure in accordance with a third embodiment;

FIG. 6 is a chart of a function W=f (H) in accordance with the third embodiment;

FIG. 7 is a schematic, cross-sectional view of a substrate structure in accordance with a fourth embodiment;

FIG. 8 is a chart of a function W=f (H) in accordance with the fourth embodiment;

FIG. 9 is a schematic, cross-sectional view of a substrate structure in accordance with a fifth embodiment;

FIG. 10 is a chart of a function W=f (H) in accordance with the fifth embodiment;

FIG. 11 is a schematic, plan view of a substrate structure in accordance with a sixth embodiment;

FIGS. 12 and 13 are schematic cross-sectional views illustrating successive stages of a method for manufacturing the substrate structure of FIG. 1;

FIGS. 14 to 18 are schematic cross-sectional views illustrating successive stages of another method for manufacturing the substrate structure of FIG. 1;

FIGS. 19 to 22 are schematic cross-sectional views illustrating successive stages of a method for forming a patterned layer using the substrate structure of FIG. 1; and

FIG. 23 is a schematic cross-sectional view of a typical substrate structure.

Reference numbers indicate corresponding parts throughout the drawings. The exemplifications set out herein illustrate at least one preferred embodiment of the invention, in one form, and such exemplifications are not to be construed as limiting the scope of the invention in any manner.

### DETAILED DESCRIPTION OF THE EMBODIMENTS

Reference will now be made to the drawings to describe the preferred embodiments of the present substrate structure and the present method in detail.

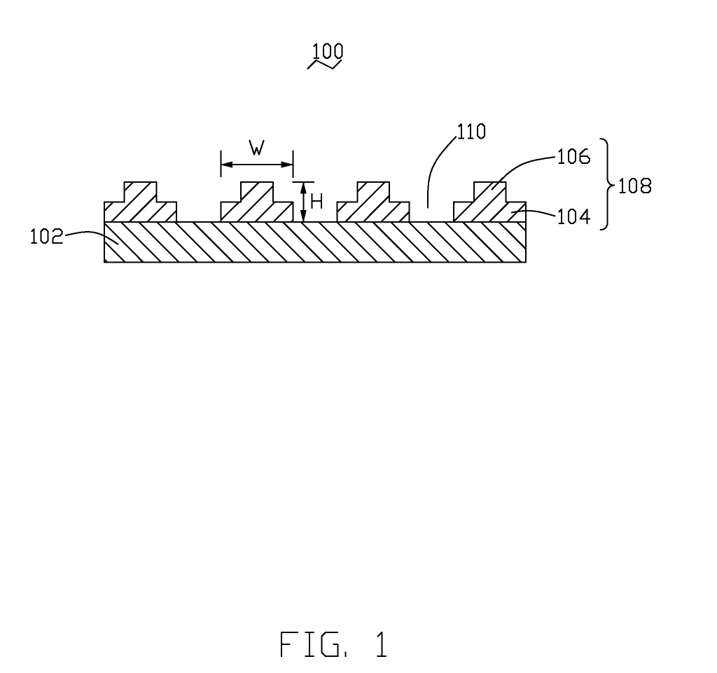

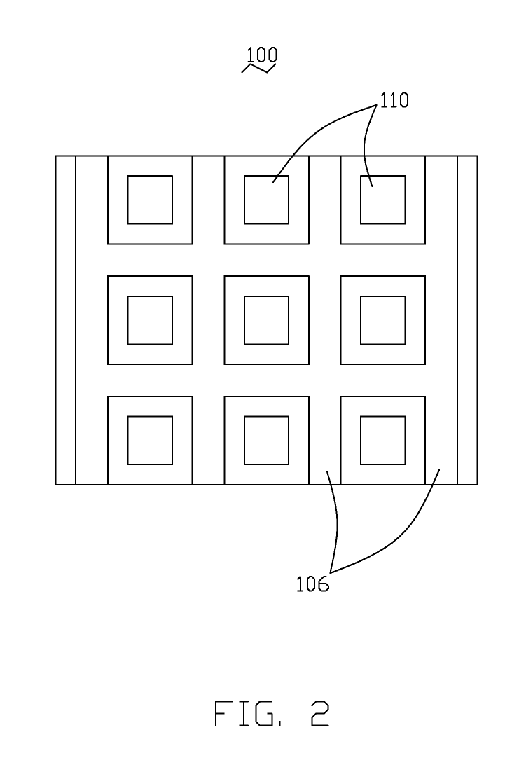

Referring to FIGS. 1 and 2, a substrate structure 100 is shown in accordance with a first embodiment. The substrate structure 100 includes a substrate 102, and a plurality of banks 108 formed on the substrate 102. The substrate 102 and the banks 108 cooperatively define a plurality of accommodating rooms 110. The accommodating rooms 110 are configured (i.e. structured and arranged) for accommodating ink. The ink can be selected from the group consisting of colored ink and black ink.

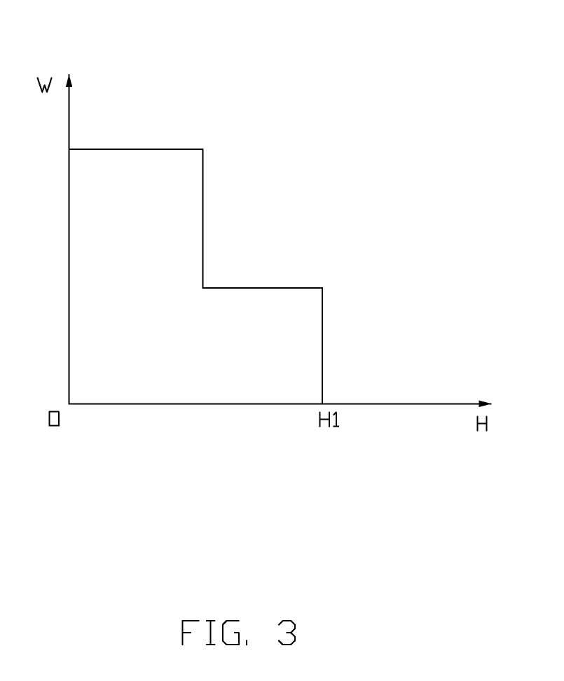

The cross-sectional width W of the bank 108 is a function of the height H of the bank 108. The chart of the function W=f (H) is shown in FIG. 3. The maximum height of the bank 108 is H1. The function W=f (H) has a discontinuity point in the interval between zero and H1. The left hand limit of the discontinuity point is larger than the right hand limit of the discontinuity point.

According to the cross-sectional width W of the bank 108, the bank 108 can be divided into two parts: a first part 104 and a second part 106. The second part 106 is a protrusion protruding from the first part 104. A cross-sectional shape of the second part 106 is rectangular.

The material of the substrate 102 can be selected from the group consisting of: glass, quartz, silicon, metal, and plastic. The substrate 102 is made of glass in the first embodiment. The banks 108 are formed on the substrate 102 by photolithography.

In order to manufacture a patterned layer, ink is deposited into the accommodating rooms 110 defined in the substrate structure 100 and then solidified. The ink is still in a liquid state when the ink is deposited into the accommodating rooms 110. When the substrate structure 100 shakes, the ink in the accommodating rooms 110 shakes also. The banks 108, particularly the second parts 106 of the banks 108, prevent the ink in an initial accommodating room 110 from diffusing into an adjacent accommodating room 110. When the ink in adjacent accommodating rooms 110 is different, the banks 108 prevent the ink from mixing. Thus the quality of the patterned layer is enhanced. When the ink in adjacent accommodating rooms 110 is the same, the banks 108 prevent the ink from mixing. Thus the evenness of the patterned layer is enhanced.

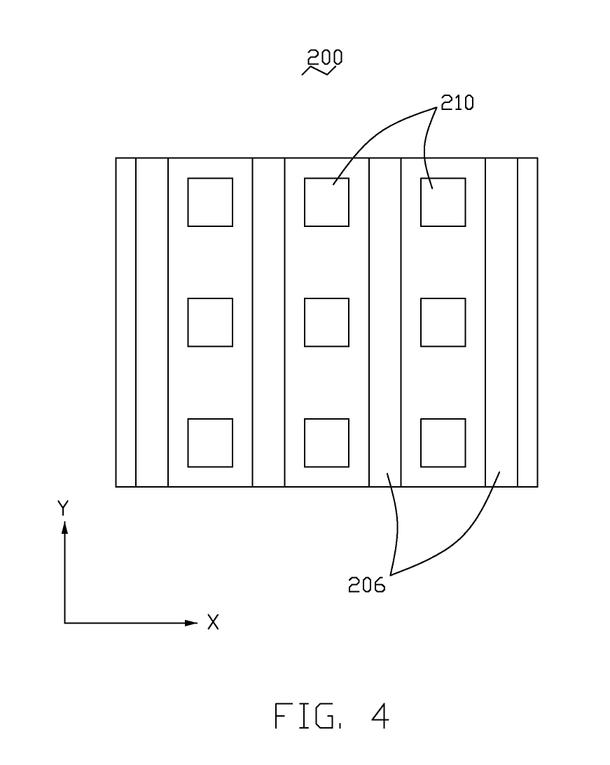

Referring to FIG. 4, a substrate structure 200 is shown in accordance with a second embodiment. The substrate structure 200 is similar to the substrate structure 100, but only banks 206 in a first direction X includes two parts while the banks 206 in a second direction Y perpendicular to the first direction X only includes the first part. The accommodating rooms 210 arranged in the first direction Y are configured for accommodating the same ink while the accommodating rooms arranged in the second direction X are configured for accommodating different inks.

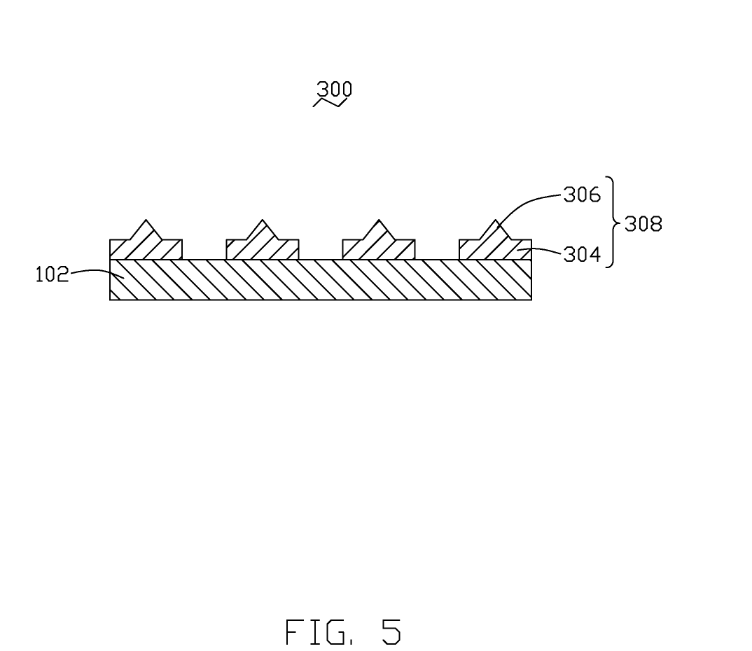

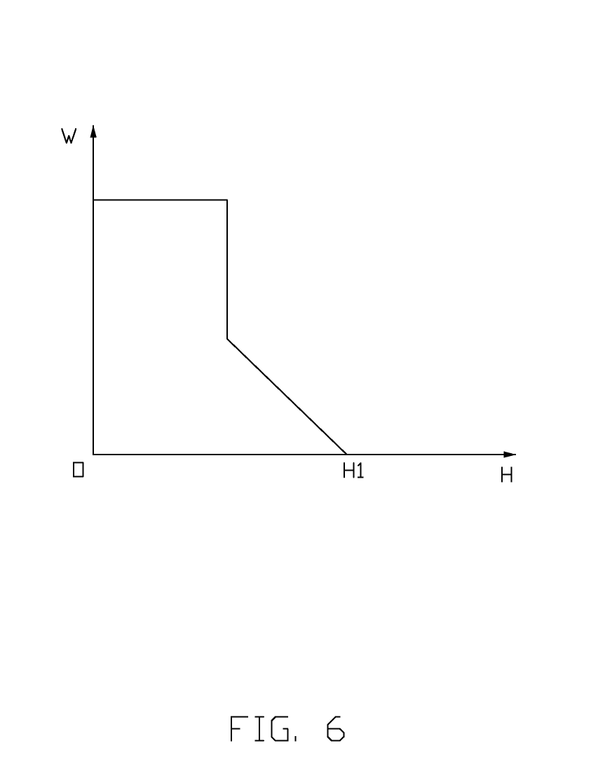

Referring to FIG. 5, a substrate structure 300 is shown in accordance with a third embodiment. The substrate structure 300 is similar to the substrate structure 100. A bank 308 includes a first part 304 and a second part 306. The second part 306 of the bank 308 has a triangular shape in cross-section. The chart of the function W=f (H) is shown in FIG. 6.

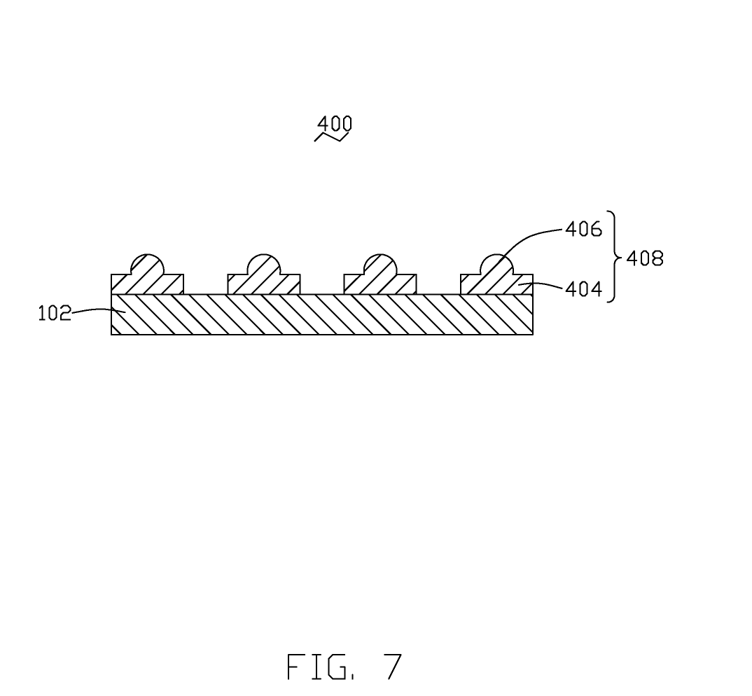

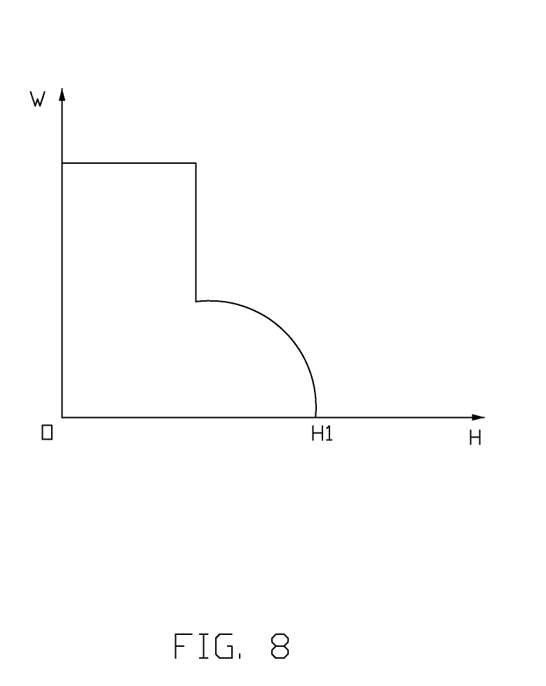

Referring to FIG. 7, a substrate structure 400 is shown in accordance with a fourth embodiment. The substrate structure 400 is similar to the substrate structure 100. A bank 408 includes a first part 404 and a second part 406. The second part 406 of the bank 408 has a convex shape in cross-section. The chart of the function W=f (H) is shown in FIG. 8.

It should be noted that the second part of the bank can also has a trapezoid shape in cross-section.

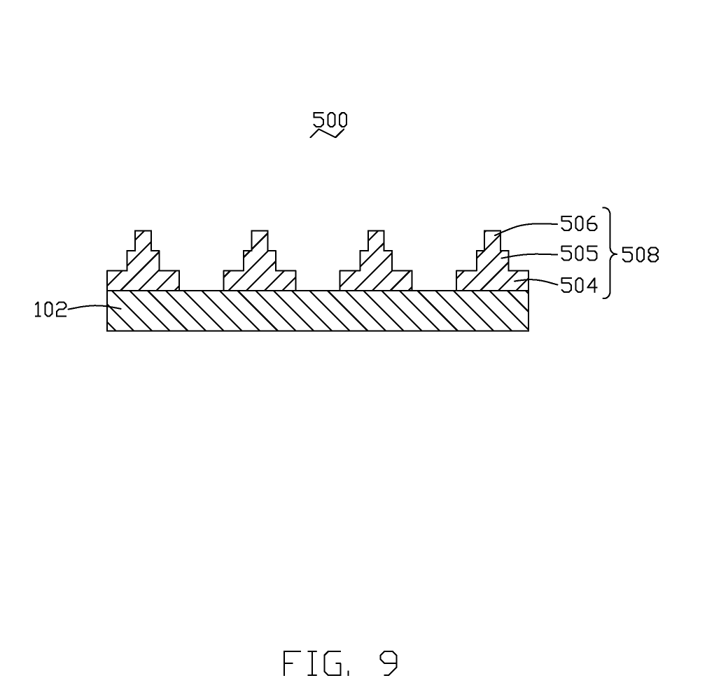

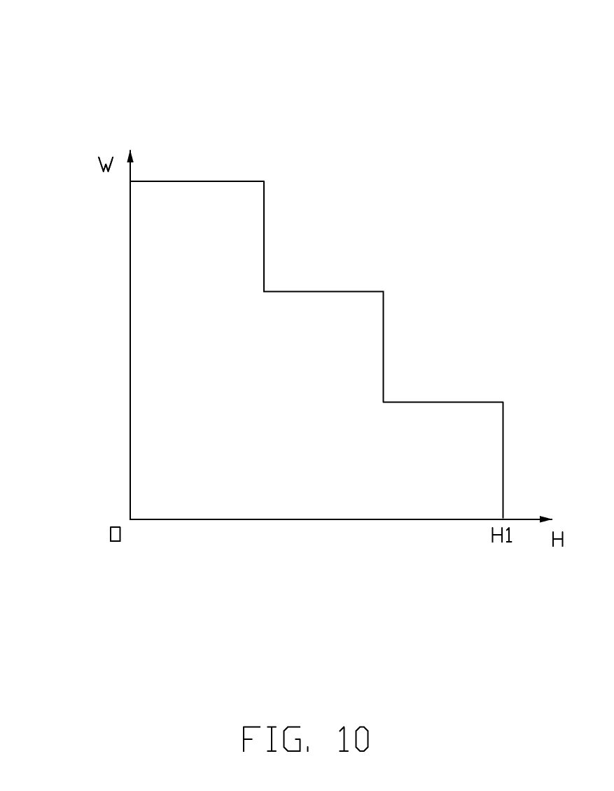

Referring to FIG. 9, a substrate structure 500 is shown in accordance with a fifth embodiment. The substrate structure 500 is similar to the substrate structure 100, but a bank 508 includes three parts 504, 505 and 506 according to the cross-sectional width of the bank. The first part 504 has a larger width in cross-section than the second part 505 while the second part 505 has a larger width than the third part 506. The function W=f (H) has two discontinuity points in the interval between zero and H1, referring to FIG. 10.

Each function W=f (H) of the substrate structure from the first embodiment to the fourth embodiment includes one discontinuity point in the interval between zero and H1. The function W=f (H) in the fifth embodiment includes two discontinuity points in the interval between zero and H1. It should be noted that the function W=f (H) can have more than two discontinuity points in the interval between zero and H1.

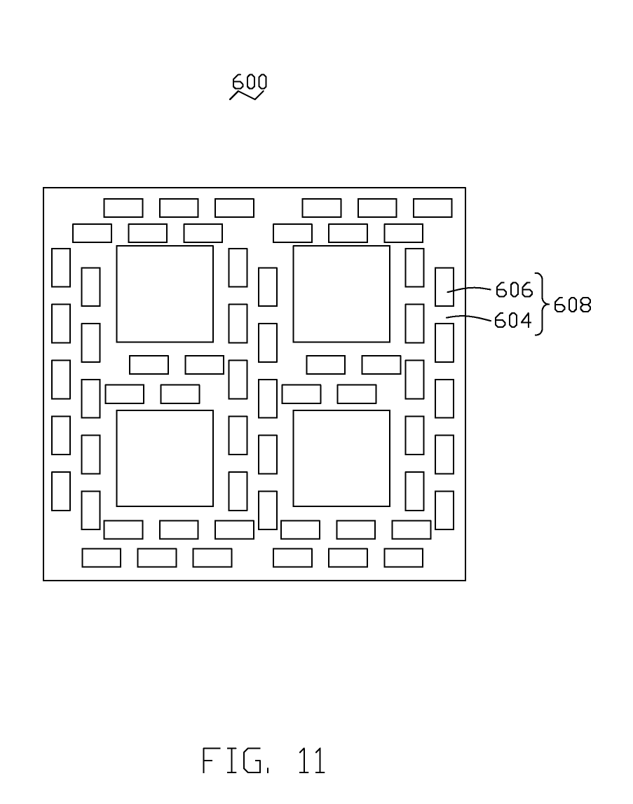

Referring to FIG. 11, a substrate structure 600 is shown in accordance with a sixth embodiment. The substrate structure 600 is similar to the substrate structure 100, but a second part of the bank 608 has two parallel rows of protrusions 606 protruding from a first part 604. Each row of protrusions 606 is discrete. The two rows of protrusions 606 are arranged in a staggered fashion.

It should be noted that the second part of the bank can be separated by more than two rows of protrusions from the first part.

A method of manufacturing a patterned layer mainly includes the following steps:

(1) providing a substrate structure;

(2) depositing ink into accommodating rooms defined in the substrate structure using a dispenser;

(3) solidifying the ink in the accommodating rooms to form a patterned layer;

(4) optionally, removing portions of the banks which extend beyond the patterned layer using a grinding method or an etching method.

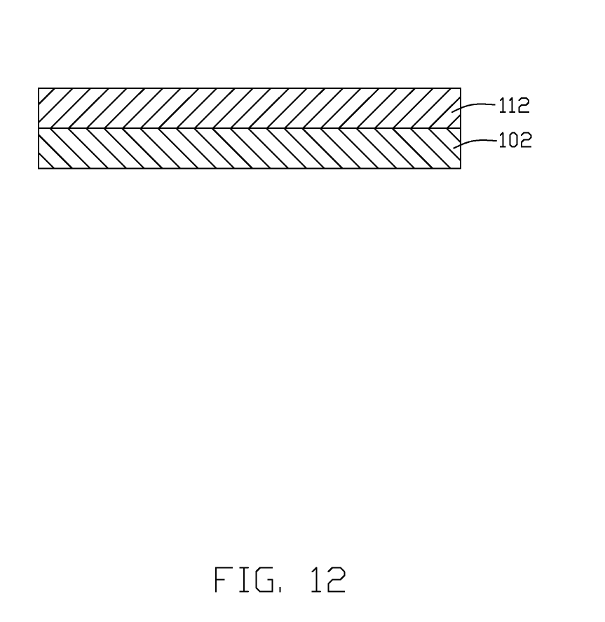

With references of FIGS. 12 to 22, the method for manufacturing a patterned layer will be described in more detail as follows.

In step 1, a substrate structure 100 is provided, referring to FIG. 1.

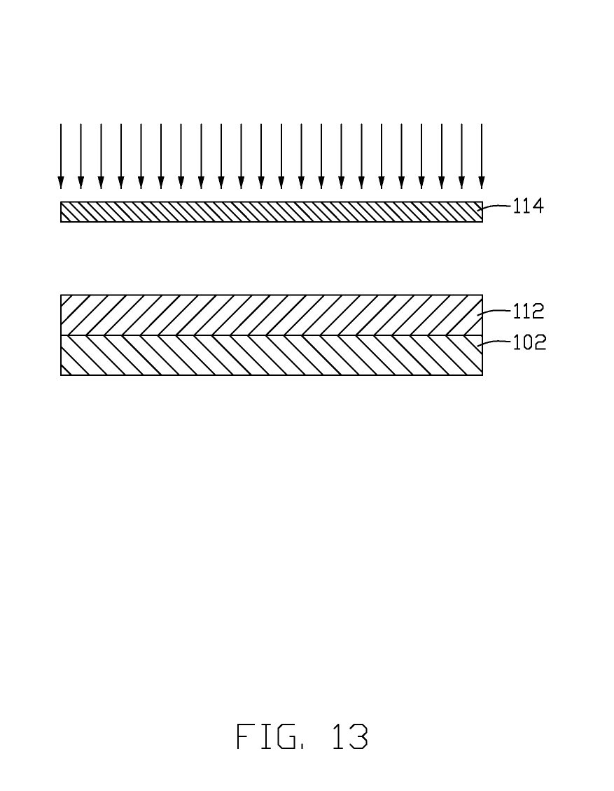

A first method of manufacturing the substrate structure 100 (referring to FIG. 1) includes the steps of: providing a substrate 102; referring to FIG. 12, applying a positive photoresist film 112 on the substrate 102 using a method selected from the group consisting of dry film lamination, wet spin coating, and wet slit coating; referring to FIG. 13, exposing the photoresist film 112 using a gray-scale photomask 114 with a predetermined pattern; and, referring to FIG. 1, developing the photoresist film 112 to form a plurality of banks 108.

The method above forms the banks 108 using the positive photoresist film 112. It should be noted that a negative photoresist film can be also used, and accordingly some changes should be made on the photomask 114.

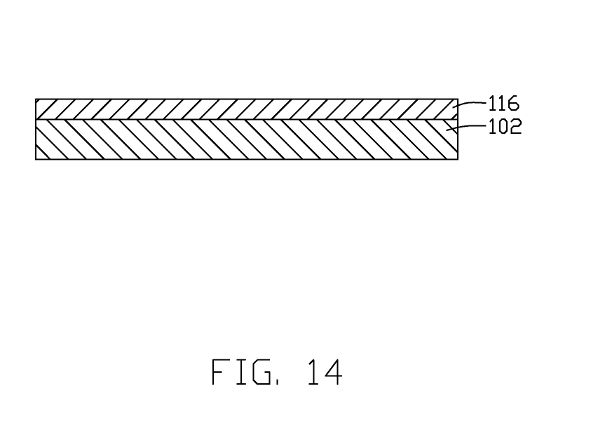

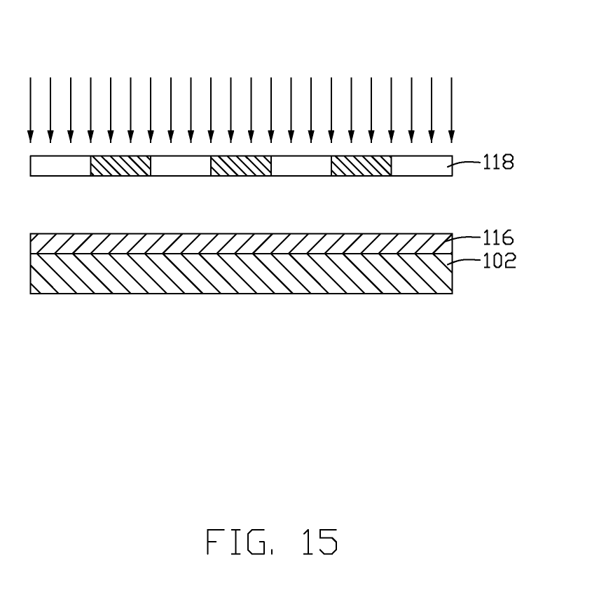

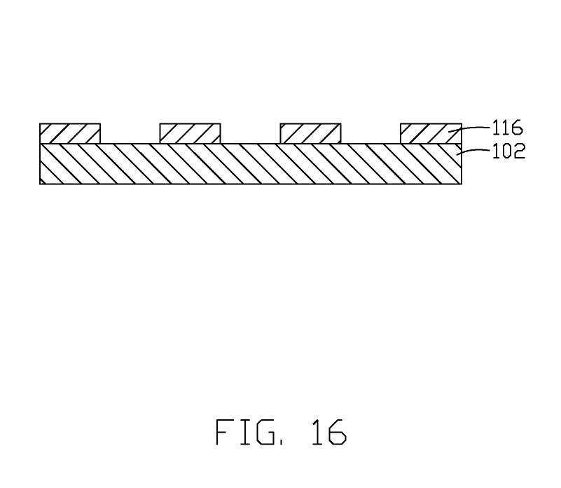

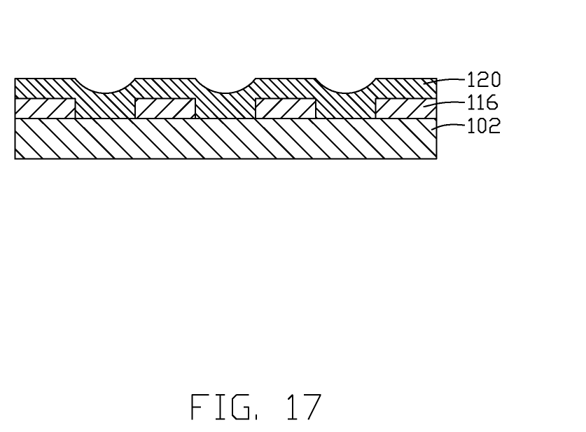

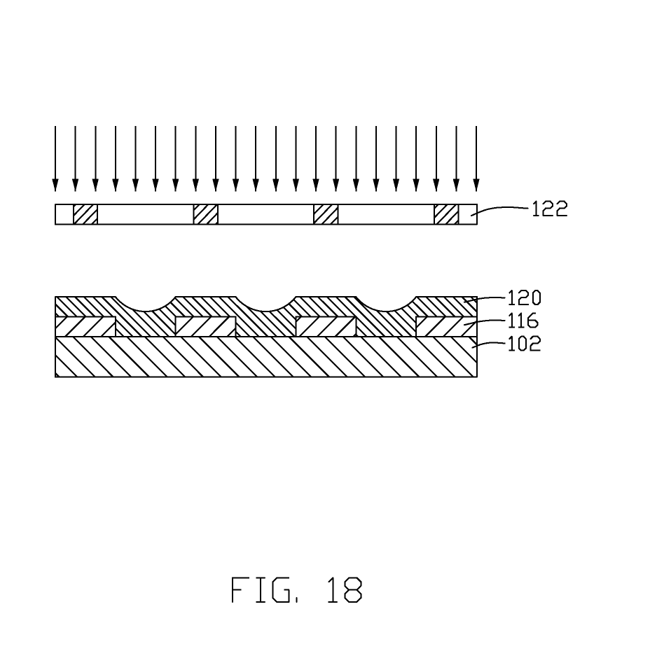

A second method of manufacturing the substrate structure 100 (referring to FIG. 1) includes the steps of: providing a substrate 102; referring to FIG. 14, applying a first negative photoresist film 116 on the substrate 102 using a method selected from the group consisting of dry film lamination, wet spin coating, and wet slit coating; referring to FIG. 15, exposing the photoresist film 116 using a first photomask 118 with a predetermined pattern; referring to FIG. 16, developing the photoresist film 116; referring to FIG. 17, applying a second negative photoresist film 120 on the substrate 102 covering the photoresist film 116 using a method selected from the group consisting of dry film lamination, wet spin coating, and wet slit coating; referring to FIG. 18, exposing the photoresist film 120 using a second photomask 122; and, referring to FIG. 1, developing the photoresist film 120 to form a plurality of banks 108.

In the second method, after exposing the photoresist film 116, the second negative photoresist film 120 can be applied immediately on the photoresist film 116. The photoresist films 116 and 120 can be developed together to form the banks 108 after exposing the photoresist film 120, referring to FIG. 1.

The second method above forms the banks using the negative photoresist film. It should be noted that a positive photoresist film can be also used.

The second method forms the banks by using the exposing-developing process twice. It should be noted that the exposing-developing process can be used more than twice if needed.

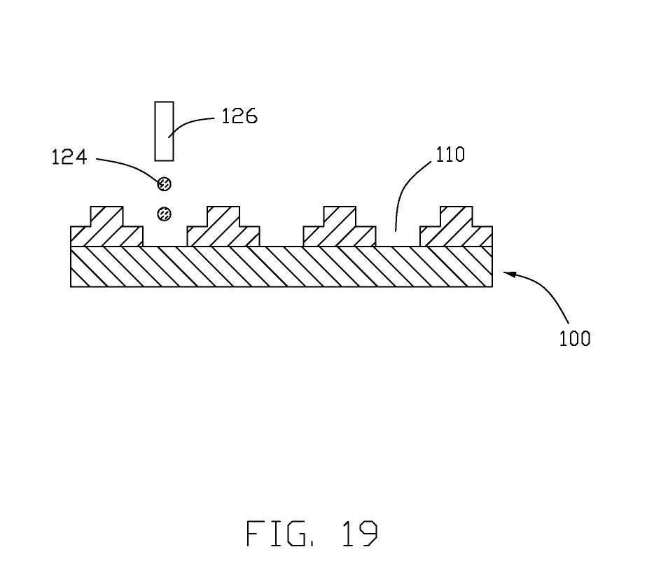

In step 2, ink 124 is deposited into the accommodating rooms 110 using a dispenser 126, referring to FIG. 19. The ink 124 is made of the material of the patterned layer. The dispenser 126 can be an ink jet device, for example, a thermal bubble ink jet device, or a piezoelectric ink jet device.

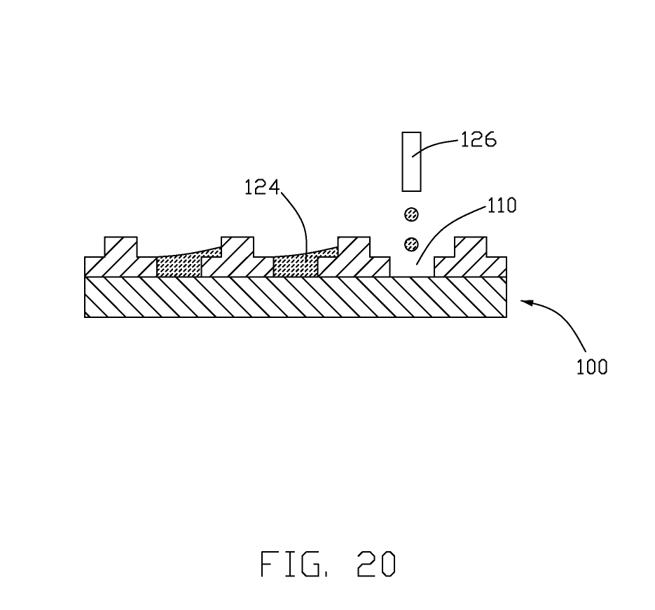

Referring to FIG. 20, the ink 124 is still in a liquid state when the ink 124 is deposited into the accommodating rooms 110. In this step, the substrate structure 100 may shake. Thus the ink 124 in the accommodating rooms 110 shakes also. The banks 108, particularly the second parts 106 of the banks 108, prevent the ink 124 from diffusing into the adjacent accommodating rooms.

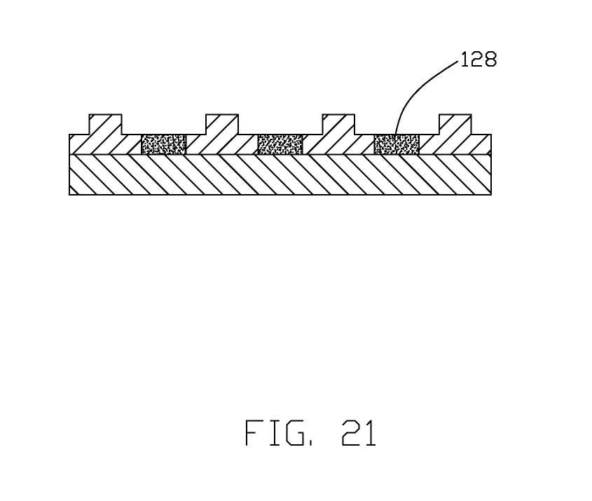

In step 3, the ink 124 is solidified to form a patterned layer 128, referring to FIG. 21. The ink 124 is solidified using at least one device chosen from the group consisting of vacuumizing devices, heating devices and light-exposure devices. The light-exposure devices include ultraviolet light-exposure devices.

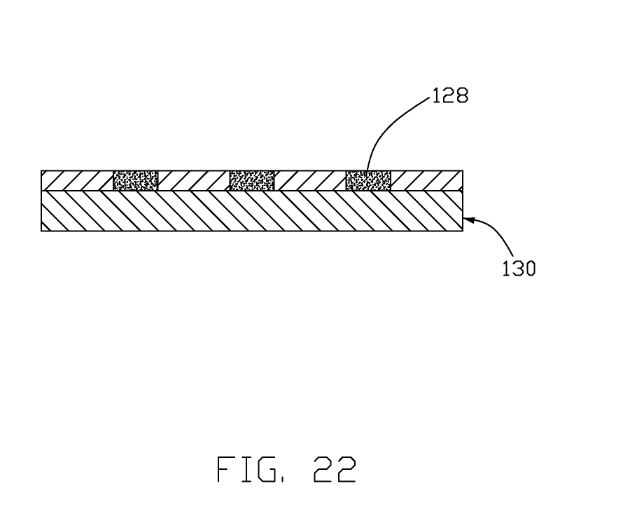

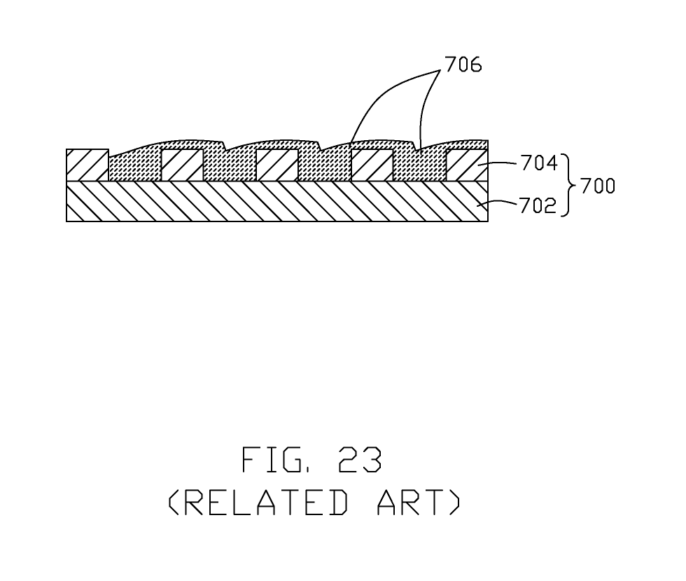

In step 4, the second parts 106 of the banks 108 which extend beyond the patterned layer 124 are optionally removed using either a grinding method or an etching method so as to obtain a smooth surface, referring to FIG. 22. Thus a patterned layer 130 is formed.

The method above manufactures the patterned layer 130 using the substrate structure 100. It should be noted that the substrate structure can be selected from the group consisting of the substrate structures from the first embodiment to the sixth embodiment.

It should be noted that the method can be used to manufacture devices such as, for example, color filters and organic light emitting display devices. In the manufacturing of color filters, the method can be used to manufacture RGB (red, green, and blue) color layers. Correspondingly, the bank mentioned above can include single layer bank (using black matrix only as the bank), or multi-layer bank (using black matrix and one or more top layers on the black matrix as the bank). In the manufacturing of an organic light emitting display device, the method can be used to manufacture, for example, emission-material layers, electron-transfer layers, hole-transfer layers and electron-ejection layers.

Although the present invention has been described with reference to specific embodiments, it should be noted that the described embodiments are not necessarily exclusive, and that various changes and modifications may be made to the described embodiments without departing from the scope of the invention as defined by the appended claims.

What is claimed is:

1. A substrate structure, comprising:
a substrate; and
a plurality of banks formed on the substrate, the banks and the substrate cooperatively defining a plurality of accommodating rooms, the accommodating rooms being configured for accommodating ink,
wherein a width W of the bank is a function of a height H of the bank, a plot of the function W=f (H) comprising at least one discontinuity point, a left hand limit at the at least discontinuity point being greater than a right hand limit at the at least one discontinuity point.

2. The substrate structure as claimed in claim 1, wherein the ink is selected from the group consisting of colored ink and black ink.

3. The substrate structure as claimed in claim 1, wherein a material of the substrate is selected from the group consisting of glass, quartz, silicon, metal and plastic.

4. A substrate structure, comprising:
a substrate; and
a plurality of banks formed on the substrate, each of the banks comprising an upper portion having a width less than that of a lower portion, the banks and the substrate cooperatively defining a plurality of accommodating rooms, the accommodating rooms being configured for accommodating ink.

5. The substrate structure as claimed in claim 4, wherein the upper portion of each of the banks is a protrusion protruding from the lower portion.

6. The substrate structure as claimed in claim 5, wherein a cross-section of the protrusion has a shape selected from the group consisting of rectangle, triangle, convex, and trapezoid.

7. The substrate structure as claimed in claim 5, wherein the upper portions of the banks are a plurality of rows of protrusions.

8. The substrate structure as claimed in claim 7, wherein the protrusions are discrete protrusions and arranged in a staggered fashion.

9. A method for manufacturing a patterned layer, comprising the steps of:
providing a substrate structure as claimed in claim 1;
depositing ink into the accommodating rooms using a dispenser; and
solidifying the ink in the accommodating rooms to form a patterned layer on the substrate structure.

10. The method as claimed in claim 9, wherein the substrate structure is made by a method comprising the steps of:
providing a substrate;
applying a photoresist film on the substrate;
exposing the photoresist film using a photomask with a predetermined pattern; and
developing the photoresist film to form a plurality of banks.

11. The method as claimed in claim 10, wherein the photomask is a gray-scale photomask.

12. The method as claimed in claim 9, wherein the substrate structure is made by a method comprising the steps of:
providing a substrate;
applying a first photoresist film on the substrate;
exposing the first photoresist film using a first photomask with a predetermined pattern;
developing the first photoresist film;
applying a second photoresist film on the first photoresist film;
exposing the second photoresist film using a second photomask with a predetermined pattern; and
developing the second photoresist film to form a plurality of banks.

13. The method as claimed in claim 9, wherein the substrate structure is made by a method comprising the steps of:
providing a substrate;
applying a first photoresist film on the substrate;
exposing the first photoresist film using a first photomask with a predetermined pattern;
applying a second photoresist film on the first photoresist film;
exposing the second photoresist film using a second photomask with a predetermined pattern; and
developing the first photoresist film and the second photoresist film to form a plurality of banks.

14. The method as claimed in claim 9, wherein the dispenser is an ink jet device.

15. The method as claimed in claim 9, wherein the ink is solidified using at least one solidifying device selected from the group consisting of the vacuumizing devices, heating devices and light-exposure devices.

16. The method as claimed in claim 15, wherein the light-exposure devices comprise ultraviolet light-exposure devices.

17. The method as claimed in claim 9, further comprising the following step after the ink is solidified: removing portions of the banks which extend beyond the patterned layer through grinding or etching.

18. The method as claimed in claim 14, wherein the ink jet device is selected from the group consisting of a thermal bubble ink jet device and a piezoelectric ink jet device.

19. A method for manufacturing a patterned layer, comprising the steps of:
providing a substrate structure as claimed in claim 4;
depositing ink into the accommodating rooms using a dispenser; and
solidifying the ink in the accommodating rooms to form the patterned layer on the substrate structure.
